(19) United States
(12) Patent Application Publication
(10) Pub. No.: US 2012/0087380 A1
(43) Pub. Date: Apr. 12, 2012

(54) MEDIA TRANSMISSION METHOD AND DEVICE AND MEDIA STORAGE METHOD AND DEVICE

(75) Inventors: Tingfang Tang, Beijing (CN); Yekui Wang, San Diego, CA (US); Zhan Peng, Beijing (CN)

(73) Assignee: Huawei Technologies Co., Ltd., Shenzhen (CN)

(21) Appl. No.: 13/328,525

(22) Filed: Dec. 16, 2011

Related U.S. Application Data
(63) Continuation of application No. PCT/CN10/73701, filed on Jun. 9, 2010.

(30) Foreign Application Priority Data
Jun. 16, 2009 (CN) 200910149424.3

(51) Int. Cl. H04L 29/02

(52) U.S. Cl. 370/474

(57) ABSTRACT

A media transmission method and device are provided. The method includes: encapsulating a content source selected by a client into data packets, adding a content identifier (ID) used to indicate each multiplexed content to a transmission adaptation layer, and sending a media stream of the encapsulated data packets to the client. Transmission multiplexing of multiple multiplexed contents may be implemented. A media storage method and device are further provided to facilitate the application of multiplexed media.

### CROSS-REFERENCE TO RELATED APPLICATIONS

This application is a continuation of International Application No. PCT/CN2010/073701, filed on Jun. 9, 2010, which claims priority to Chinese Patent Application No. 200910149424.3, filed on Jun. 16, 2009, both of which are hereby incorporated by reference in their entireties.

### FIELD OF THE INVENTION

The present invention relates to the field of communication technologies, and in particular, to a media transmission method and device and a media storage method and device.

### BACKGROUND OF THE INVENTION

With the enhancement of terminal capabilities, more and more types of terminals are available. Therefore, providing differentiated terminal users with diversified and high-quality user experiences has become a key technology in multimedia services. For example, to improve the quality of media data presentations, caption information in a multimedia stream is no longer embedded in a video stream but is used as a synchronized timed text (TT) media stream for independent transmission. In addition, with the introduction of multiple media types, concurrently presenting multiple media contents on a screen becomes a common scene. Even for the same media type, different media contents may also be presented concurrently, for example, the picture in picture of a video, an advertising video, an advertisement timing bar, and a channel logo presented concurrently in an advertisement.

At a scene where multiple media contents need to be presented concurrently, the media contents may be multiplexed for transmission so as to save network bandwidths effectively. In some cases, the number of ports may also be reduced.

Therefore, in the prior art, media contents may be split for transmission, or media contents are transcoded and combined for transmission, or media contents are directly multiplexed without transmitting a content identifier (ID). The transmitted media is generally encapsulated by using a Real-time Transport Protocol (RTP) format, for example, a RTP transmission format of Dynamic and Interactive Multimedia Scenes (DIMS) in the 3rd Generation Partnership Project (3GPP), a RTP transmission format of H.264 media data specified in IETF RFC 3984, and a RTP transmission format of TT specified in IETF RFC 4396.

No matter which transmission format is used, the prior art has the following disadvantages:

Media contents cannot be identified; when multiple contents are presented concurrently, no differentiated control parameter can be set for different contents, and the processing performance of a terminal may be degraded and even service control errors may occur. For example, for a play control service, when a channel plays an advertisement, the media contents such as an advertisement timing bar and a channel logo are presented concurrently; the advertisement timing bar matches the advertisement, but the channel logo is independent of the advertisement; however, a pause operation may pause all the media contents, and cannot pause only the advertisement and the matched advertisement timing bar.

In addition, in the prior art, multiplexed contents in a program or a movie need to be stored as multiple files, which causes inconvenience to media applications. For example, if a user consumes the movie in a streaming form, ordinary streaming services such as the packet switched streaming service (PSS) of the 3GPP is not applicable because the PSS assumes that each movie is stored in a file.

### SUMMARY OF THE INVENTION

In one aspect, embodiments of the present invention provide a media transmission method and device to save network bandwidths and enhance a processing capability of a terminal.

In another aspect, embodiments of the present invention provide a media storage method and device to facilitate an application of multiplexed media.

A media transmission method provided in an embodiment of the present invention includes:

encapsulating a content source selected by a client into a data packet, and adding a content identifier (ID) used to indicate multiplexed content to a transmission adaptation layer; and

sending a media stream of the encapsulated data packet to the client.

A media transmission method provided in an embodiment of the present invention includes:

receiving a media stream sent from a server;

if the media stream is media multiplexed for content-based transmission, obtaining from a transmission adaptation layer a content ID used to indicate each multiplexed content; and

parsing the media stream according to the content ID, and decoding and presenting the media stream.

A server provided in an embodiment of the present invention provides includes:

an encapsulating unit, configured to encapsulate a content source selected by a client into a data packet, and add a content identifier (ID) used to indicate multiplexed content to a transmission adaptation layer; and

a media stream sending unit, configured to send a media stream of the encapsulated data packet to the client.

A client provided in an embodiment of the present invention includes:

a media stream receiving unit, configured to receive a media stream sent from a server;

a content ID obtaining unit, configured to obtain from a transmission adaptation layer a content ID used to indicate each multiplexed content when the media stream is media multiplexed for content-based transmission;

a parsing unit, configured to parse the media stream according to the content ID; and

a presenting unit, configured to decode and present the media stream parsed by the parsing unit.

An embodiment of the present invention provides a media storage method, including:

storing multiplexed contents of a same multiplexed media type in a file; and

marking a content ID and a multiplexing indication on the multiplexed contents in the file.

A media storage device provided in an embodiment of the present invention provides a media storage device includes:

a storing unit, configured to store multiplexed contents of a same multiplexed media type in a file; and

an information describing unit, configured to mark a content ID and a multiplexing indication on the multiplexed contents in the file.

By using the media transmission method and device provided in embodiments of the present invention, at a server side, a content source selected by the client is encapsulated into data packets; a content ID used to indicate each multiplexed content is added to the transmission adaptation layer, and the media stream of the encapsulated data packets is sent to the client. Accordingly, at a client side, the media stream sent from the server is received; if the media stream is media multiplexed for content-based transmission, a content ID used to indicate each multiplexed content is obtained from the transmission adaptation layer, the media stream is parsed according to the content ID, and the media stream is decoded and presented. In this way, the network bandwidth may be saved, and the processing capability of the terminal may be enhanced.

By using the media storage method and device provided in embodiments of the present invention, for the applicability of presenting multiple media contents in parallel, multiplexed contents of the same multiplexed media type are stored in a file, and a content ID and a multiplexing indication are marked on the multiplexed contents in the file, which facilitates the application of the multiplexed media.

### BRIEF DESCRIPTION OF THE DRAWINGS

FIG. 1 is a flowchart of a media transmission method according to an embodiment of the present invention;

FIG. 2 is a flowchart of a media transmission method according to an embodiment of the present invention;

FIG. 3 is a schematic structure diagram of a server according to an embodiment of the present invention;

FIG. 4 is a schematic structure diagram of a client according to an embodiment of the present invention;

FIG. 5 is a flowchart of delivering Session Description Protocol (SDP) information by a server according to an embodiment of the present invention;

FIG. 6 is a flowchart of sending and receiving media multiplexed for content-based transmission according to an embodiment of the present invention;

FIG. 7 is a schematic diagram of time for presenting multiple media contents according to an embodiment of the present invention;

FIG. 8 is a flowchart of implementing transmission of multiple multiplexed media contents of a same media type according to an embodiment of the present invention;

FIG. 9 is a flowchart of implementing transmission of multiple multiplexed media contents of a same media type according to an embodiment of the present invention;

FIG. 10 is a schematic structure diagram of an aggregated packet encapsulated for multiplexing transmission by using an RTP encapsulation format according to an embodiment of the present invention;

FIG. 11 is a flowchart of a media storage method according to an embodiment of the present invention;

FIG. 12 is a schematic structure diagram of a file storing multiplexed contents according to an embodiment of the present invention;

FIG. 13 is a flowchart of a media storage method according to an embodiment of the present invention;

FIG. 14 is another schematic structure diagram of a file storing multiplexed contents according to an embodiment of the present invention; and

FIG. 15 is a schematic structure diagram of a media storage device according to an embodiment of the present invention.

### DETAILED DESCRIPTION OF THE EMBODIMENTS

To enable those skilled in the art to further understand the technology disclosed by the present invention and the features thereof, the present invention is described in detail below with reference to the accompanying drawings. The accompanying drawings are provided for reference and illustration only, and not intended to limit the present invention.

For better description, several concepts involved in embodiments of the present invention are first described below:

element media type: refers to a single media type, for example, TT;

aggregated media type: refers to a media type including or citing one media type or a combination of multiple single media types, for example, timed graphics (TG);

multiplexed contents: refer to multiple media contents of the same media type that need to be presented concurrently.

An embodiment of the present invention provides a media transmission method. According to the method, at a server side, a content source selected by the client is encapsulated into data packets; a content ID used to indicate each multiplexed content is added to the transmission adaptation layer, and the media stream of the encapsulated data packets is sent to the client. Accordingly, at a client side, the media stream sent from the server is received; if the media stream is media multiplexed for content-based transmission, a content ID used to indicate each multiplexed content is obtained from the transmission adaptation layer, the media stream is parsed according to the content ID, and the media stream is decoded and presented.

The following describes the media transmission method provided in embodiments of the present invention in detail from the perspective of the server side and the client side respectively.

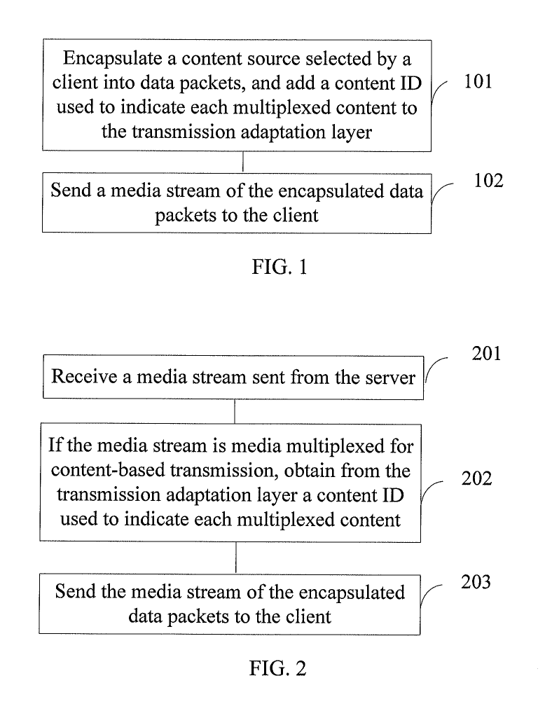

FIG. 1 is a flowchart of a media transmission method according to an embodiment of the present invention. The method includes the following steps.

Step 101: Encapsulate a content source selected by the client into data packets, and add a content ID used to indicate each multiplexed content to a transmission adaptation layer.

Specifically, the content source selected by the client is encapsulated into data packets in a content multiplexing mode, that is, multiple media contents of the same media type that need to be presented concurrently are multiplexed.

The transmission adaptation layer may be a RTP or a Hypertext Transfer Protocol (HTTP), that is, the data packets are encapsulated through RTP or HTTP.

Encapsulating the content source into data packets includes at least one of the following: encapsulating a single data unit into a data packet; or encapsulating a single data unit fragment into a data packet; or encapsulating multiple data units into a data packet on an aggregated basis; or encapsulating multiple data unit fragments into a data packet on an aggregated basis; or encapsulating multiple data units and data unit fragments into a data packet on an aggregated basis. The encapsulation formats for different data packets are described in detail in the latter part of the specification.

Accordingly, adding a content ID used to indicate each multiplexed content to the transmission adaptation layer may include: adding a content ID corresponding to the data unit or a content ID corresponding to the data unit fragment to the data packet header, or adding a content ID to an aggregated data packet header and/or adding a content ID corresponding to an aggregated data unit to the aggregated data unit header, where the aggregated data unit refers to a single data unit or a single data unit fragment and the aggregated data packet refers to the aggregation of aggregated data units. Each aggregated data unit includes data units or data unit fragments of the same time, or data units or data unit fragments of different time.

Step 102: Send a media stream of the encapsulated data packets to the client.

The content source may be of a single media type, for example, TT, or be of an aggregated media type, for example, TG.

The embodiment of the present invention may implement single transmission, aggregated transmission, or fragmented transmission based on a content ID.

The following describes the data packet encapsulation modes in different transmission modes.

1. Single Transmission of a Data Packet

Single transmission of a data packet means that only a single data unit is encapsulated in a data packet. Transmission based on a content ID means that a content ID parameter CCN (that is, the content ID) is added to the data packet header. For example, the content ID parameter is added to a RTP header in the case of RTP encapsulation. This parameter occupies one byte and is a positive integer, which is used to mark different contents in the media stream. For example, in the case of HTTP encapsulation, a header field parameter may be added to identify the content ID parameter CCN.

2. Fragmented Transmission of a Data Packet

Fragmented transmission of a data packet means that only fragments of a data unit are encapsulated into a data packet. This mode is similar to the foregoing encapsulation mode. When the data packet is encapsulated, the content ID parameter (that is, the content ID) CCN may be added to the data packet header. For example, this parameter occupies one byte and is a positive integer, which is used to mark different contents in the media stream.

3. Aggregated Transmission of a Data Packet

The embodiment of the present invention supports aggregations of multiple single data units or multiple data unit fragments or aggregations of combinations of data units and data unit fragments. For better description, the foregoing aggregations are collectively referred to as aggregated data units. In this aggregation mode, the encapsulation of the data packet may adopt the following mode:

(1) Add the content ID parameter CCN to the aggregated data packet header. If all the aggregated data units in the aggregated data packet adopt the same content ID parameter, the value of content ID parameter CCN carried in the aggregated data packet header is the same as the value of the content ID parameter of the aggregated data unit; otherwise, a corresponding rule is specified to assign a value to the content ID parameter CCN in the aggregated data packet header. In addition, a specific value may be set to meaningless. If all the aggregated data units in the aggregated data packet belong to the same content, the content ID parameter CCN may also be added to the aggregated data packet header only, and the content ID parameter in each aggregated data unit may be omitted.

(2) The content ID parameter may not be added to the aggregated data packet header, and the content ID parameter corresponding to the aggregated data unit may be added to the header of each aggregated data unit in the aggregated data packet.

The aggregated data units in the aggregated data packet may be the aggregated data units of the same time, that is, aggregated data units of single time, or be the aggregated data units of different time, that is, aggregated data units of multiple time. For the transmission of aggregated data units of single time, the foregoing transmission solution may be adopted, and a time stamp (TS) indicating the single time only needs to be added to the aggregated data packet header. For the transmission of aggregated data units of multiple time, a TS offset mode in the H.264 transmission solution may be adopted, that is, the TS in the aggregated data packet header is a minimum TS in all the data packets, and a TS offset is added to the header of each aggregated data unit of the aggregation.

In content-based transmission multiplexing, if the element media types of each content are different or the element media types are the same but the formats are different, related information may be carried in the transmission adaptation layer to identify each content, so that the terminal performs differentiated codec processing on each content. This difference is referred to as a content type difference. The content type difference may be identified by using a profile parameter. The following describes the modes of encapsulating related parameters.

(1) Add a parameter to the data packet header to identify the profile. For example, a 4-bit parameter is encapsulated with the content ID of a data packet into each data packet above. The enumerated values corresponding to the four bits identify the corresponding profiles.

(2) Carry related description information, for example, profile, in a data packet header of an individual type. For example, the TT packet adopts five types of formats, of which Type 5 is used to transmit the sample description dynamically. The content type difference related descriptions may be added to the sample description for transmission, so that these descriptions are transmitted to the terminal together with the sample description of the content ID.

In the embodiment of the present invention, before encapsulating, in content multiplexing mode, the content source selected by the client into data packets, the method may further include the following step: receive a content service request message sent from the client, where the message includes a content source requested by the client; generate SDP information corresponding to the content source, and send the SDP information to the client, where the SDP information carries a content-based transmission multiplexing ID.

In step 101, the content source may be selected by the client according to a capability requirement of the client and the content-based transmission multiplexing ID carried in the SDP information.

The foregoing transmission multiplexing ID may be carried by extending related parameters in the SDP information. Because the multiplexing is performed for the same media type, related parameters are parameters of the media layer.

Specifically, the transmission multiplexing ID may include the maximum number of multiplexed transmitted contents only, which is carried through an extended SDP attribute line. In addition, the transmission multiplexing ID may further include a multiplexing indication ID, which is carried through an extended SDP attribute line.

Several specific identification methods may be used:

(1) Extend an SDP attribute line to indicate the maximum number of multiplexed transmitted contents, that is, the maximum number of contents of the same media type multiplexed and transmitted in parallel in a related media stream. A special value (for example, 0) may be set to indicate that content multiplexing transmission is not supported.

(2) Extend an SDP attribute to indicate the content-based transmission multiplexing ID and maximum number of multiplexed transmitted contents, where the content-based transmission multiplexing ID indicates whether content-based transmission multiplexing is supported and the maximum number of multiplexed transmitted contents indicates the maximum number of contents of the same media type multiplexed and transmitted in parallel in a related media stream. When content-based transmission multiplexing is supported, the maximum number of multiplexed transmitted contents is valid.

Specifically, the following definitions may be used:

The syntax of the content-based transmission multiplexing ID is defined as follows:

cntmultiplex-attribute=“a=cntmultiplex” content-multiplex

content-multiplex=token; yes|no

The syntax of the maximum number of multiplexed transmitted contents is defined as follows:

contentnum-attribute=“a=maxcntnum:” content-num *(SP content-num)

content-num=integer

In the foregoing two methods, the maximum number of multiplexed transmitted contents may be an integer or an integer list. Possible applications of this parameter are as follows:

a. This parameter has only one value for a media type, no matter whether the media type is element media or aggregated media, where the value only identifies the number of multiplexed contents of the media type. If the same media description further includes parameters such as profiles of media related parameters, the number of multiplexed contents indicates the number of multiplexed contents of the profile corresponding to the media type. For the aggregated media type, the media type including the element media types of the same format may be considered to be a profile. The same profile has the same decoding requirement. The profiles in the session description include related subsets, for example, if a profile supports the element media type TT+Image (PNG)+Graphics, any combination of the TT/Image(PNG)/Graphics (including the case that only one element media type is included) is also within the range.

b. For the aggregated media, the number of multiple element media types or multiple profiles (referring to profiles including media related parameters of the element media types) in the aggregated media may be described by using a value list or multiple attributes of a single value. That is, if the media multiplexed for transmission is aggregated media, the transmission multiplexing ID further includes: a value list or multiple SDP attribute lines of a single value corresponding to multiple element media types in the aggregated media or corresponding to the number of profiles of media related parameters of multiple element media types in the aggregated media.

By using the media transmission method provided in the embodiment of the present invention, transmission multiplexing of multiple multiplexed contents may be supported, and network bandwidths are saved. In addition, when multiple media contents are presented concurrently, differentiated control parameters may be set for different contents respectively. Furthermore, when a media session is established, a content-based transmission multiplexing ID is carried in the SDP information, so that the terminal may perform processing properly according to the capability of the terminal.

FIG. 2 is a flowchart of a media transmission method according to an embodiment of the present invention. The method includes the following steps:

Step 201: Receive a media stream sent from a server.

Step 203: If the media stream is media multiplexed for content-based transmission, obtain from a transmission adaptation layer a content ID used to indicate each multiplexed content.

The content-based transmission multiplexing means that the contents are transmitted in a content multiplexing mode, that is, multiple media contents of the same media type that need to be presented concurrently are multiplexed.

The media stream may be of a single media type, for example, TT, or be of an aggregated media type, for example, TG.

Step 204: Parse the media stream according to the content ID, and decode and present the media stream.

In the embodiment of the present invention, the method may further include the following steps:

Before receiving the media stream, send a content service request message to the server; receive SDP information sent from the server, where the SDP information carries a content-based transmission multiplexing ID; and select the content source according to the capability requirement and the content-based transmission multiplexing ID carried in the SDP information.

By using the media transmission method provided in the embodiment of the present invention, transmission multiplexing of multiple multiplexed contents may be supported, and network bandwidths are saved. When multiple media contents are presented concurrently, differentiated control parameters may be set for different contents respectively.

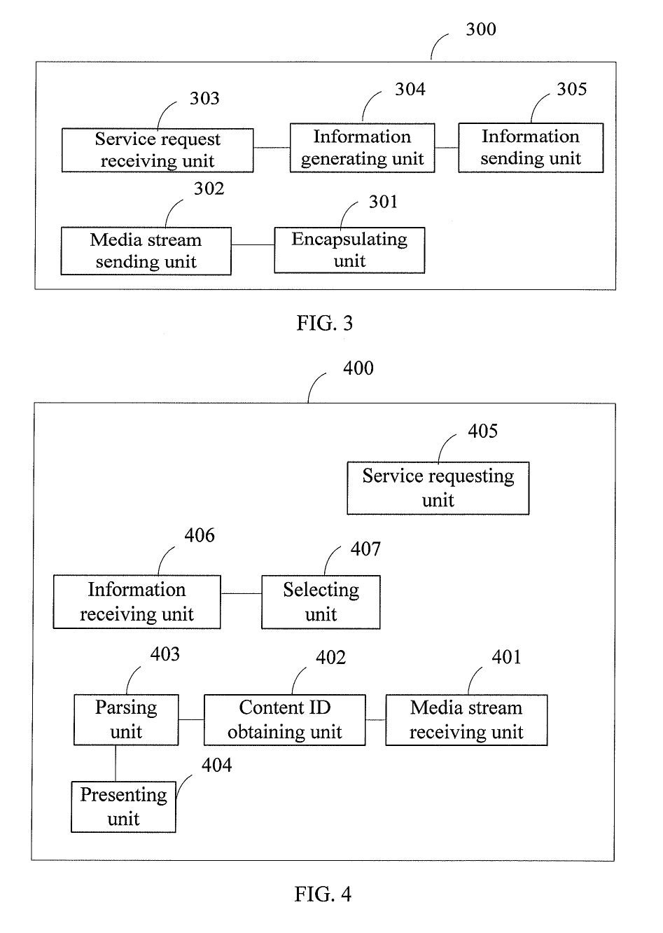

Accordingly, an embodiment of the present invention provides a server. FIG. 3 is a schematic structure diagram of the server.

In this embodiment, the server 300 includes: an encapsulating unit 301 and a media stream sending unit 302.

The encapsulating unit 301 is configured to encapsulate a content source selected by a client into data packets, and add a content ID used to indicate each multiplexed content to a transmission adaptation layer.

Specifically, the encapsulating unit 301 encapsulates, in a content multiplexing mode, the content source selected by the client into data packets, that is, the encapsulating unit 301 multiplexes multiple media contents of the same media type that need to be presented concurrently.

Encapsulating the content source into data packets may include encapsulating a single data unit into a data packet or encapsulating a single data unit fragment into a data packet. In this case, the encapsulating unit 301 adds the content ID corresponding to the data unit or the data unit fragment to the data packet header.

Encapsulating the content source into data packets may include encapsulating multiple data units into a data packet on an aggregated basis, or encapsulating multiple data unit fragments into a data packet on an aggregated basis, or encapsulating multiple data units and data unit fragments into a data packet on an aggregated basis. In this case, the encapsulating unit 301 adds a content ID to the aggregated data packet header and/or adds a content ID corresponding to an aggregated data unit to the aggregated data unit header, where the aggregated data unit is a single data unit or a data unit fragment and the aggregated data packet is the aggregation of aggregated data units.

For the specific encapsulation formats in different cases, references may be made to the descriptions of the media transmission method provided in the foregoing embodiments of the present invention. Details are omitted herein.

The media stream sending unit 302 is configured to send a media stream of the encapsulated data packets to the client.

The content source requested by the client may be of a single media type, for example, TT, or be of an aggregated media type, for example, TG.

In the embodiment of the present invention, the server 300 may further include: a service request receiving unit 303, an information generating unit 304 and an information sending unit 305.

The service request receiving unit 303 is configured to receive a content service request message sent from the client, where the message includes a content source requested by the client.

The information generating unit 304 is configured to generate SDP information corresponding to the content source after the service request receiving unit 304 receives the content service request, where the SDP information carries a content-based transmission multiplexing ID.

The information sending unit 305 is configured to send the SDP information.

In this way, the client can select a corresponding content source according to the capability requirement of the client and the content-based transmission multiplexing ID carried in the SDP information. That is, the foregoing content source may be selected by the client according to the capability requirement of the client and the content-based transmission multiplexing ID carried in the SDP information.

By using the server provided in the embodiment of the present invention, transmission multiplexing of multiple multiplexed contents may be supported, and network bandwidths are saved. When multiple media contents are presented concurrently, differentiated control parameters may be set for different contents respectively. Furthermore, when a media session is established, a content-based transmission multiplexing ID is carried in the SDP information, so that the terminal may perform processing properly according to the capability of the terminal.

Accordingly, an embodiment of the present invention provides a client. FIG. 4 is a schematic structure diagram of the client.

In this embodiment, the client 400 includes: a media stream receiving unit 401, a content ID obtaining unit 402, a parsing unit 403 and a presenting unit 404.

The media stream receiving unit 401 is configured to receive a media stream sent from the server.

The content ID obtaining unit 402 is configured to obtain from a transmission adaptation layer a content ID used to indicate each multiplexed content when the media stream is media multiplexed for content-based transmission.

The parsing unit 403 is configured to parse the media stream according to the content ID.

The presenting unit 404 is configured to decode and present the media stream parsed by the parsing unit 403.

In the embodiment of the present invention, the client 400 may further include: a service requesting unit 405, an information receiving unit 406 and a selecting unit 407.

The service requesting unit 405 is configured to send a content service request message to the server before the media stream receiving unit 401 receives the media stream.

The information receiving unit 406 is configured to receive SDP information sent from the server, where the SDP information carries a content-based transmission multiplexing ID.

The selecting unit 407 is configured to select the content source according to the capability requirement of the client and the content-based transmission multiplexing ID carried in the SDP information.

By using the client provided in the embodiment of the present invention, transmission multiplexing of multiple multiplexed contents may be supported, and network bandwidths are saved. When multiple media contents are presented concurrently, differentiated control parameters may be set for different contents respectively.

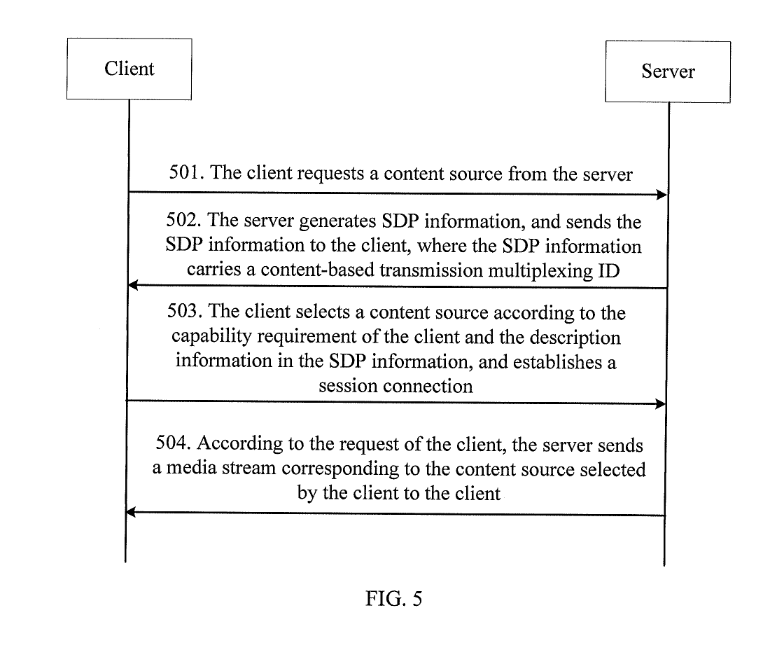

FIG. 5 is a flowchart of delivering SDP information by the server according to an embodiment of the present invention.

Step 501: The client sends a content service request to the server, requesting a content source.

Step 502: The server generates SDP information corresponding to the content source, and sends the SDP information to the client, where the SDP information includes multiple types of information corresponding to the content source, for example, content-based transmission multiplexing ID.

Step 503: After receiving the SDP information, the client selects a content source according to the capability requirement of the client and the description information in the SDP information, and establishes a session connection.

Step 504: According to the request of the client, the server sends the media stream corresponding to the content source selected by the client to the client.

If the content source selected by the client is media multiplexed for content-based transmission, when the media is encapsulated for transmission, the server needs to encapsulate the content source into data packets in a content multiplexing mode and add a content ID used to indicate each multiplex content to the transmission adaptation layer, that is, the content ID is included in the encapsulation header. Otherwise, the content ID is not included in the encapsulation header.

It should be noted that the process of sending SDP information by the server in the embodiment of the present invention is applicable to the foregoing process and may also be completed by using an SDP Offer/Answer mechanism. The specific process is similar to the prior art, and is not described in detail herein again.

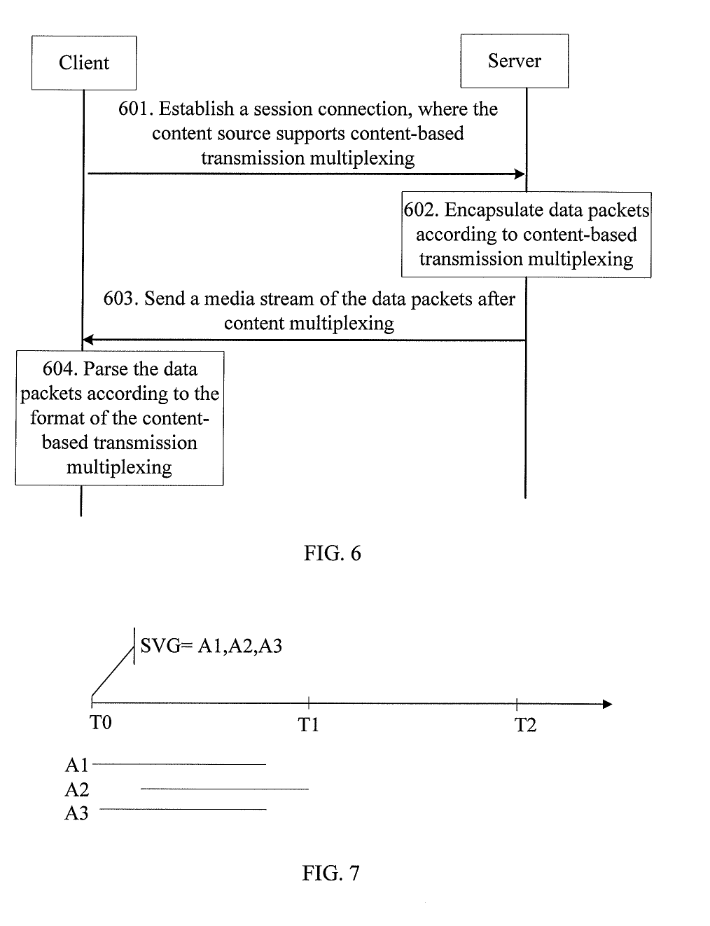

FIG. 6 is a flowchart of sending and receiving media multiplexed for content-based transmission according to an embodiment of the present invention.

Step 601: The client already establishes a connection with the server. Both the client and the server support content-based transmission multiplexing.

Step 602: The server encapsulates, in a content multiplexing mode, a content source selected by the client into data packets, and adds a content ID used to indicate each multiplexed content to the transmission adaptation layer.

Step 603: The server sends the media stream of the data packets after content multiplexing.

Step 604: The client parses the received data packets of the media stream. Specifically, the client identifies the received media stream according to the content ID, and decodes and parses the media stream, so that multiple media contents that are multiplexed for transmission can be presented concurrently.

Persons of ordinary skill in the art understand that all or part of the steps of the methods in the foregoing embodiments may be implemented by a program instructing relevant hardware. The program may be stored in a computer readable storage medium. The storage medium may be a read only memory or random access memory (ROM/RAM), a magnetic disk, or a compact disk-read only memory (CD-ROM).

The following further describes the specific applications of the media transmission method provided in this embodiment by taking some examples.

### Example 1

It is assumed that A1, A2, and A3 are three animations complying with the scalable vector graphics (SVG) syntax. These animations are described by using the media contents of the SVG syntax and deployed in the streaming service. A1, A2, and A3 are of the same media type (assuming that the related media type is the sub-type 3gpp-x of the video) and have an intersection in terms of presentation time, as shown in FIG. 7.

A content-based transmission multiplexing solution is used. Session control between the client and the server is implemented through Real Time Streaming Protocol (RTSP) signaling, and the real-time media transmission is implemented over RTP.

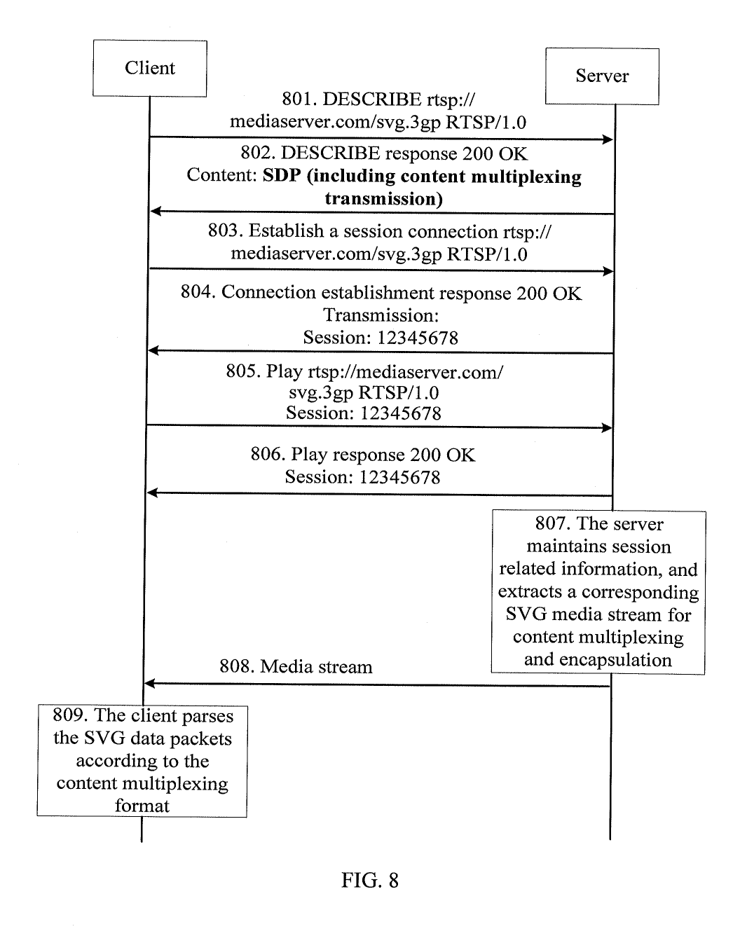

FIG. 8 illustrates a main process of content-based transmission multiplexing.

Step 801: The client initiates a DESCRIBE request, requesting to obtain SDP information provided by the server.

Step 802: The server sends a DESCRIBE response message that carries the SDP information of a content-based transmission multiplexing ID. In this embodiment, the content-based transmission multiplexing ID is represented by the maximum number of multiplexed transmitted contents. Assuming the maximum number of multiplexed transmitted contents in parallel of the media contents of the 3gpp-x type is 3, an example of the SDP description is as follows:

m=video <port> RTP/AVP 98

a=rtpmap: 98 3gpp-x/1000

a=maxcntnum: 3

Step 803: The client parses the SDP information, and obtains information parameters corresponding to the media. According to the capability of the client, the client judges whether content-based transmission multiplexing is supported; if so, the client selects a related content source according to step 804 to step 806, and establishes a session connection. The client may also optimize the terminal resource scheduling according to content multiplexing. If the terminal does not support content-based transmission multiplexing, the client performs other processing. For example, if the server provides the same content service via other transmission techniques in addition to content-based transmission multiplexing, the client may initiate a related request for establishing a connection; if the server supports content-based transmission multiplexing only, the client may terminate the request for related contents.

Step 804: The server feeds back a connection establishment response message.

Step 805 to step 806: The client interacts with the server to request playing media.

Step 807: The server maintains session related information, and extracts a corresponding SVG media stream for content multiplexing and encapsulation. The server adds a content ID parameter to the encapsulated RTP header, and transmits data units on a single/an aggregated/a fragmented basis.

In this embodiment, content multiplexing transmission is implemented by extending the DIMS-based transmission solution. For better understanding of the solution provided in this embodiment, the following briefly describes the RTP encapsulation format of the DIMS in the prior art.

The RTP encapsulation format of the DIMS includes an RTP header, while a DIMS unit includes a public header, a special header, and sampled contents. The sampled contents have four encapsulation types, including aggregated data packet and fragmented packet. The public header indicates a specific encapsulation type used.

The specific encapsulation format of content multiplexing transmission in this embodiment includes the following information:

(1) A DIMS header: A content ID parameter CCN (that is, the content ID) is added to the header of the data unit. This parameter occupies one byte and is a positive integer. Different contents in the media stream are marked by numbers.

(2) A public header: Similar to the prior art, the public header supports single transmission/aggregated transmission/fragmented transmission. In this embodiment, the aggregated data packet supports the aggregation of single data packets only and does not support the aggregation of data unit fragments and single data units or aggregation of multiple fragments.

In this embodiment, when the server encapsulates A1, A2, and A3, the foregoing content ID parameter is carried, and the encapsulation is performed on a single/an aggregated/a fragmented basis according to the size of the actual data traffic.

For example, the CCN of A1 is 1, the CCN of A2 is 2, and the CCN of A3 is 3.

Step 808: The server sends the encapsulated data packets to the client.

Step 809: The client extracts the received media stream, parses and presents each content.

The client may parse and present each content by using different decoders. For a received data packet, the client identifies the data of each content by using the header parameter at the transmission adaptation layer, and buffers and parses the data according to each content.

### Example 2

Texts of different characteristics are deployed in the streaming service. For example, in a news broadcast process, the news title, news caption, and corner prompt information are presented in different periods, different colors, different sizes, and different modes. Assuming the news title, news caption, and corner prompt information are marked as A1, A2, and A3 respectively, the media type thereof (assumed to be the sub-type 3gpp-tt of the video) is the same and, A1, A2, and A3 have an intersection in terms of presentation time.

This example is implemented by using a content-based transmission multiplexing solution. Session control between the client and the server is implemented through RTSP signaling, and the real-time media transmission is implemented over RTP.

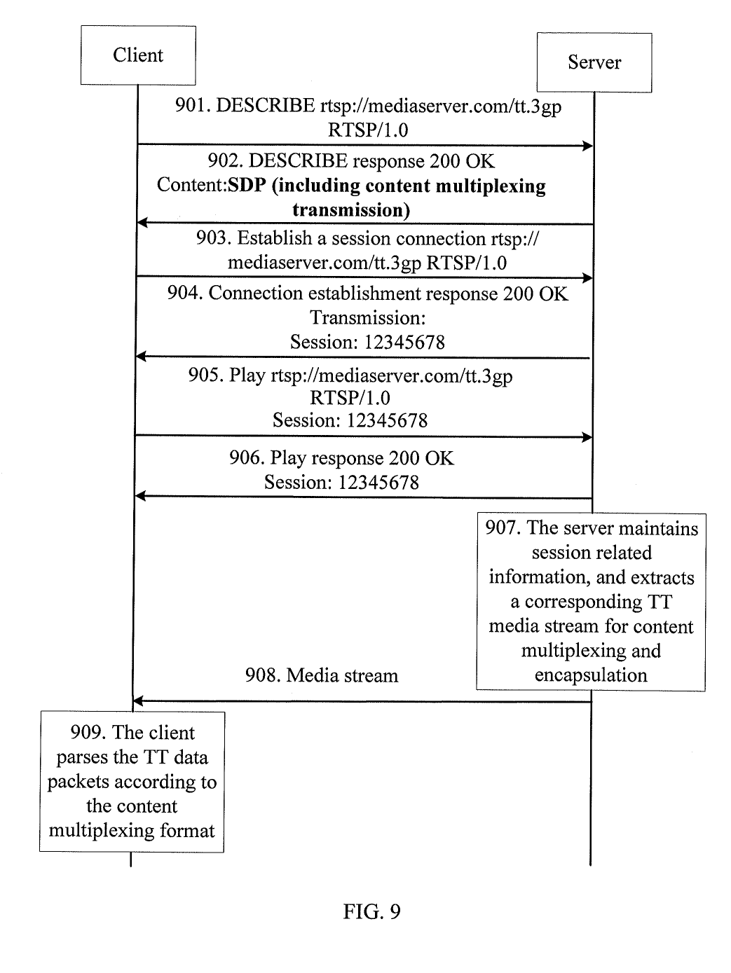

FIG. 9 illustrates a main process of content-based transmission multiplexing.

Step 901: The client initiates a DESCRIBE request, requesting to obtain SDP information provided by the server.

Step 902: The server sends a DESCRIBE response message that carries the SDP information of the content-based transmission multiplexing ID. The content multiplexing in this embodiment is represented by the combination of the content-based transmission multiplexing ID and the maximum number of multiplexed transmitted contents. Assuming the maximum number of multiplexed transmitted contents in parallel of the media contents of the 3gpp-tt type is 3, an example of the SDP description is as follows:

m=video <port> RTP/AVP 98

a=rtpmap: 98 3gpp-tt/1000

a=cntmultiplex: yes

a=maxcntnum: 3

. . .

Step 903: The client parses the SDP information, and obtains parameters corresponding to the media. According to the capability of the client, the client judges whether content-based transmission multiplexing is supported. If content-based transmission multiplexing is supported, the client selects a related content source according to step 904 to step 906, and establishes a session. In addition, the client may optimize the terminal resource scheduling according to content multiplexing.

Step 904: The server feeds back a connection establishment response message.

Step 905 to step 906: The client interacts with the server to request a playing media.

Step 907: The server maintains session related information, and extracts a corresponding TT media stream for content multiplexing and encapsulation. In addition, the server adds a content ID parameter to the encapsulated RTP header, and transmits data units on a single/an aggregated basis according to the actual transmission requirement.

In this embodiment, content multiplexing transmission is implemented by using a TT-based transmission solution. The specific transmission format includes:

(1) A public header: A content ID parameter (that is, the content ID) is added to the public header of a data unit. This parameter occupies one byte and is a positive integer. Different contents in the media stream are marked by numbers, that is, the packet headers of Type 1 to Type 5 include corresponding content ID parameters.

(2) An aggregated data packet header: The conventional TT transmission technology does not support aggregated transmission. In this embodiment, the extended Type 0 is an aggregated data packet, the data of which may be any data packet of Type 1 to Type 5. The aggregated data packet header may include a content ID parameter. Details are as follows:

The aggregated data packet header includes a content ID parameter: If all the sub data units in the aggregated data packet adopt the same content ID parameter, the value of the content ID parameter in the aggregated data packet header is the same as the value of the content ID parameter of the sub data units; otherwise, a corresponding rule is specified to assign a value to the content ID parameter in the aggregated data packet header. In addition, a specific value may be set to meaningless.

The aggregated data packet header does not include a content ID parameter. In this case, a corresponding content ID parameter may be carried in the header of a sub data unit only.

(3) Other information in the transmission format is the same as the prior art, and the transmission of a single data unit/data unit fragment may be supported.

In this embodiment, when the server encapsulates A1, A2, and A3, the foregoing content ID parameter is carried, and the encapsulation is performed on a single/an aggregated/a fragmented basis according to the size of the actual data traffic. For example, the content ID parameter of A1 is 1, the content ID parameter of A2 is 2, and the content ID parameter of A3 is 3.

Step 908: The server sends the encapsulated data packets to the client.

Step 909: The client extracts the received media stream, parses and presents each content.

The client may parse and present each content by using different decoders. For a received data packet, the client identifies the data of each content by using the header parameter at the transmission adaptation layer, and buffers and parses the data according to each content.

### Example 3

The content-based multiplexing transmission in the media transmission method provided in this embodiment is not only applicable to a single media type but also applicable to rich media applications. For example, a1 is an animation complying with the SVG syntax, a2 is a corresponding caption, and a3 includes multiple pictures. a1 is described by using the media content of the SVG syntax, the contents of a2 are transmitted by using the TT, and the pictures of a3 are downloaded over HTTP. The combination of a1, a2, and a3 forms a media content A1. Similarly, the description content of the sub media type SVG a1′ and TT caption a2′ are combined into a media content A2, which is deployed in the same channel in the streaming service. A1 and A2 have an intersection in terms of presentation time.

The process between the client and the server is similar to that described in the foregoing two embodiments, and includes a session control process and a real-time media transmission process.

The session control process needs a session ID for content multiplexing transmission, where the session ID is used by the client to confirm the capability.

The real-time media transmission process may be implemented over RTP or HTTP.

The encapsulation solution in this embodiment is described as follows:

(1) Add a content ID parameter CCN (that is, the content ID) to a data unit header.

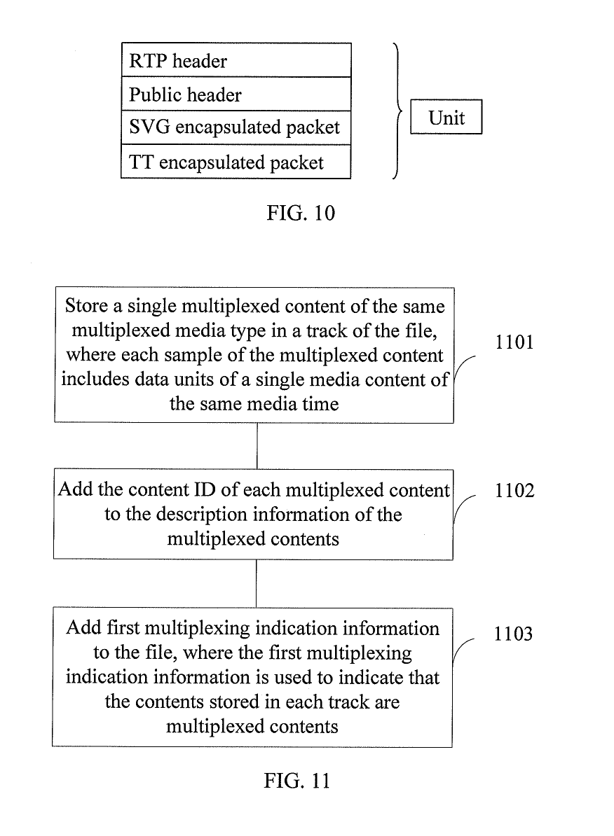

The RTP encapsulation format is shown in FIG. 10, where the content ID parameter CCN may be placed in the public header or in the header of the SVG encapsulated packet and the header of the TT encapsulated packet respectively. For a data packet aggregating different element types, the IDs of data packets of each element type may be described in the public header or in the header of a data packet of a corresponding element type. When all the data packets in the aggregated data packet belong to one content, the content ID parameter CCN may be encapsulated in the public header only; otherwise, the content ID parameter CCN may be encapsulated in each sub data packet.

For the HTTP encapsulation format, a header field parameter may be added to identify the content ID parameter CCN.

Similarly to the foregoing two embodiments, when the server encapsulates A1 and A2, the foregoing content ID parameter CCN is carried, and the encapsulation is performed on a single/an aggregated/a fragmented basis according to the size of the actual data traffic. Accordingly, the client extracts the received media stream, parses and presents each content. The client may parse and present each content by using different decoders. For a received data packet, the client identifies the data of each content by using the header parameter at the transmission adaptation layer, and buffers and parses the data according to each content.

By using the media transmission method and device provided in the foregoing embodiments of the present invention, at a scene where multiple media contents need to be presented concurrently, content-based multiplexing transmission is provided, and transmission multiplexing of multiple multiplexed contents is supported. In this way, the network bandwidths can be saved, and the processing performance of the terminal can be enhanced.

In the prior art, multiplexed contents in a program or a movie need to be stored as multiple files, which causes inconvenience to the media application. For example, if a user consumes the movie in the streaming form, ordinary streaming services such as the PSS of the 3GPP is not applicable because the PSS assumes that each movie is stored in a file.

To solve this problem, an embodiment of the present invention provides a media storage method. For the applicability of presenting multiple media contents in parallel, multiplexed contents of the same multiplexed media type are stored in a file, for example, a file in an ISO format or similar format, and a content ID and a multiplexing indication are marked on the multiplexed contents in the file, which facilitates the application of the multiplexed media.

The multiplexed contents may be stored in various modes in the file. The technical solution provided in the embodiments of the present invention is hereinafter described with reference to the accompanying drawings and embodiments.

FIG. 11 illustrates a process of implementing a media storage method according to an embodiment of the present invention. The process includes the following steps:

Step 1101: Store a single multiplexed content of the same multiplexed media type in a track of a file, where each sample of the multiplexed content includes data units of a single media content of the same media time.

The multiplexed media type may be the foregoing element media type or aggregated media type.

To further increase the storage flexibility, a prefix used to indicate a length of the data unit may be set before the data unit. For example, the length of the prefix is set to two bytes, which does not include a length of the length information, that is, the length is a payload length of the data unit.

Step 1102: Add the content ID of each multiplexed content to description information of the multiplexed contents.

Specifically, a track ID of the track storing the multiplexed content may be used to indicate the content ID of the multiplexed content. Certainly, other IDs different from the track ID may also be used.

Specifically, the content ID may be stored at a movie layer of the file or a track layer of the file.

Step 1103: Add first multiplexing indication information to the file, where the first multiplexing indication information is used to indicate that the contents stored in each track are multiplexed contents.

Specifically, the first multiplexing indication information may be stored at the movie level of the file or the track level of the file.

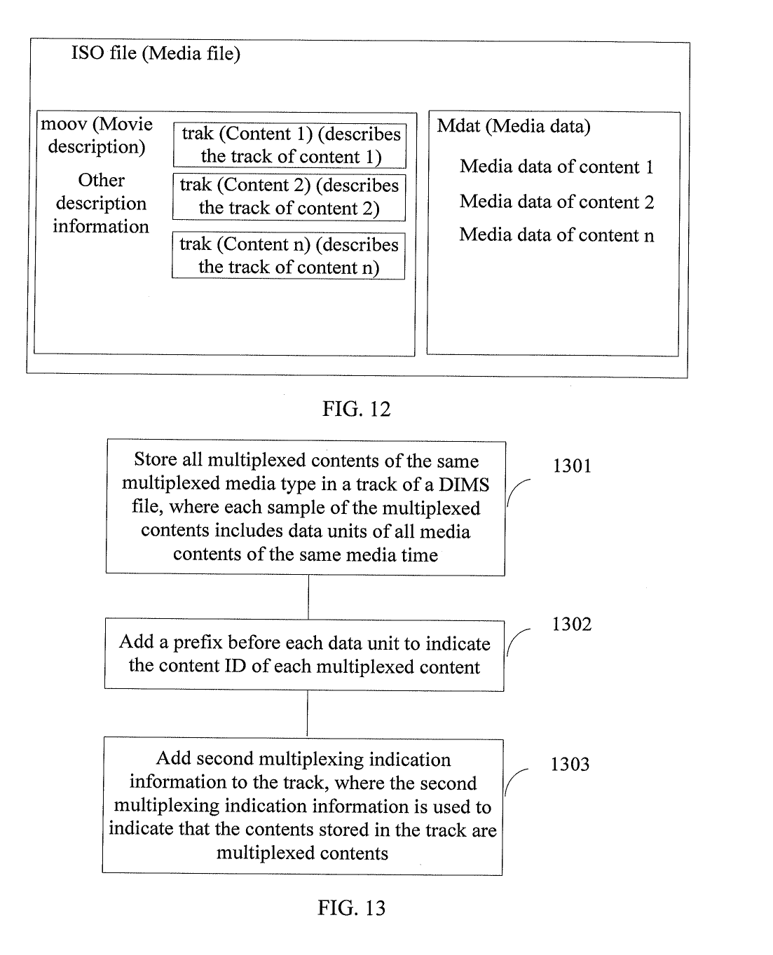

FIG. 12 illustrates a structure of a file storing multiplexed contents according to the foregoing storage method.

As shown in FIG. 12, each multiplexed content is stored in a track of the file respectively. Each sample of the multiplexed contents includes data units of a single media content of the same media time.

The content ID of each single content among the multiplexed contents may be a track ID of each track, or the content ID information may be included in the file. The content ID and the first multiplexing indication information may be stored at the movie level of the movie description, for example, the Movie Header Box, or be stored at the track level, for example, the Media Information Box or the Media Information Header Box of the track storing each single content.

The media data of each multiplexed content is stored in the sequence of samples. Each sample includes all data units of a single media content of the same media time. The prefix of each data unit includes two-byte length information, and the value of the prefix does not include the length of the length information.

Media files stored by using the method provided in the embodiment of the present invention may be played on the server or downloaded for playing locally. In addition, real-time transmission may be implemented by using the mode described in the media transmission method provided in the foregoing embodiments of the present invention. In this way, multiple media contents can be presented concurrently, which facilitates the application of multiplexed media.

FIG. 13 illustrates another process of implementing a media storage method according to an embodiment of the present invention. The process includes the following steps:

Step 1301: Store all multiplexed contents of the same multiplexed media type in a track, where each sample of the multiplexed contents includes all data units of all media contents of the same media time.

The multiplexed media type may be the foregoing element media type or aggregated media type.

Step 1302: Add a prefix before each data unit to indicate the content ID of each multiplexed content.

Step 1303: Add second multiplexing indication information to the track, where the second multiplexing indication information is used to indicate that the contents stored in the track are multiplexed contents.

Specifically, the second multiplexing indication information may be stored at the track level of the file. Preferably, the second multiplexing indication information may be stored in a sample entry of the track.

To further increase the storage flexibility, a prefix used to indicate the length of the data unit may be set before the data unit. For example, the length of the prefix is set to two bytes, which does not include the length of the length information, that is, the length is the payload length of the data unit.

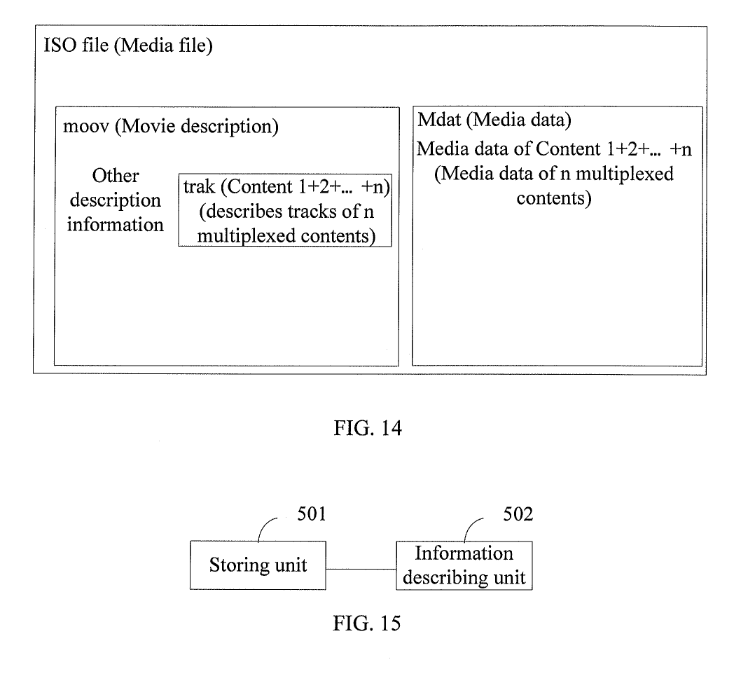

FIG. 14 illustrates a structure of a file storing multiplexed contents according to the foregoing storage method.

As shown in FIG. 14, all the single contents of the same multiplexed media type are stored in a track of a file. Each sample of the media data includes all the data units (for example, TG units) of all the contents of the same media time. The content ID is marked in the prefix of each data unit.

The track storing the multiplexed contents needs to include indication information indicating that contents stored in the track are multiplexed contents. This indication information may be stored at the track level of the movie description. Preferably, the indication information is stored in the sample entry of the track.

Media files stored by using the method provided in this embodiment of the present invention may be played on the server or downloaded for playing locally. In addition, real-time transmission may be implemented by using the mode described in the media transmission method provided in the foregoing embodiments of the present invention. In this way, multiple media contents can be presented concurrently, which facilitates the application of multiplexed media.

Accordingly, in the media transmission method provided in the foregoing embodiments of the present invention, content sources that can be provided by the server may be stored by using the foregoing media storage method. In this way, when content-based multiplexing transmission is implemented, the content sources may be encapsulated into data packets more easily. Certainly, when media streams multiplexed for content-based transmission are received and stored on a real-time basis, the media streams may also be stored according to the foregoing media storage method, so that subsequent processing is more convenient.

An embodiment of the present invention also provides a media storage device. FIG. 15 is a schematic structure diagram of the media storage device.

In this embodiment, the media storage device includes a storing unit 1501 and an information describing unit 1502.

The storing unit 1501 is configured to store multiplexed contents of a same multiplexed media type in a file.

The information describing unit 1502 is configured to mark a content ID and a multiplexing indication on the multiplexed contents in the file.

In specific applications, the multiplexed contents may be stored in the file in various modes.

In an embodiment of the present invention, the storing unit 1501 is configured to store a single multiplexed content of the same multiplexed media type in a track of the file. Each sample of the multiplexed content includes data units of a single media content of the same media time. The information describing unit 1502 is configured to add the content ID of each multiplexed content to the description information of the multiplexed contents, and add first multiplexing indication information to the file, where the first multiplexing indication information is used to indicate that contents stored in each track are multiplexed contents. For the specific media storage process, references may be made to the description of the media storage method shown in FIG. 11. Details are omitted herein.

In another embodiment of the present invention, the storing unit 1501 is configured to store all multiplexed contents of the same multiplexed media type in a track of the file. Each sample of the multiplexed contents includes all data units of all the media contents of the same media time. The information describing unit 1502 is configured to add a prefix before each data unit to indicate the content ID of each multiplexed content, and add second multiplexing indication information to the track, where the second multiplexing indication information is used to indicate that contents stored in the track are multiplexed contents. For the specific media storage process, references may be made to the description of the media storage method shown in FIG. 13. Details are omitted herein.

Different from the method for transmitting broadcast and TV transmit streams, the methods provided in the foregoing embodiments of the present invention add a content ID used to indicate each multiplexed content to the transmission adaptation layer, which reduces the load occupied by the packet header and saves bandwidth resources.

Persons of ordinary skill in the art understand that all or part of the steps of the methods in the foregoing embodiments may be implemented by a program instructing relevant hardware. The program may be stored in a computer readable storage medium. The storage medium may be a ROM/RAM, a magnetic disk, or a CD-ROM.

The foregoing embodiments of the present invention are not intended to limit the scope of the present invention. Any modification, equivalent replacement, or improvement made without departing from the spirit and principle of the present invention should fall within the scope of the present invention.

1. A media transmission method, comprising:
encapsulating a content source selected by a client into a data packet, and adding a content identifier (ID) used to indicate multiplexed content to a transmission adaptation layer; and
sending a media stream of the encapsulated data packet to the client.

2. The method according to claim 1, wherein:
the encapsulating the content source into the data packet comprises: encapsulating a single data unit into a data packet; or encapsulating a single data unit fragment into a data packet; and
the adding the content ID used to indicate multiplexed content to the transmission adaptation layer comprises: adding a content ID of the data unit or a content ID of the data unit fragment to the data packet header.

3. The method according to claim 1, wherein the encapsulating the content source into the data packet comprises one of: encapsulating multiple data units into the data packet; or encapsulating multiple data unit fragments on an aggregated basis; or encapsulating multiple data units and data unit fragments into the data packet on an aggregated basis; and
the adding the content ID used to indicate multiplexed content to the transmission adaptation layer comprises at least one of:
adding the content ID to the aggregated data packet header; and adding a content ID of an aggregated data unit to an aggregated data unit header;
wherein, the aggregated data unit is one of a single data unit or a data unit fragment, and the aggregated data packet is an aggregation of aggregated data units.

4. The method according to claim 3, wherein the aggregated data unit comprises one of data units or data unit fragments of the same time or the aggregated data unit comprises data units or data unit fragments of different time.

5. The method according to claim 1, further comprising:
receiving a content service request message sent from the client, wherein the message comprises the content source requested by the client; and
generating Session Description Protocol (SDP) information corresponding to the content source, and sending the SDP information to the client, wherein the SDP information carries a content-based transmission multiplexing ID;
the content source is selected by the client according to a capability requirement of the client and the content-based transmission multiplexing ID carried in the SDP information.

6. The method according to claim 5, wherein the transmission multiplexing ID comprises the maximum number of multiplexed transmitted contents and is comprised in an extended SDP attribute line.

7. The method according to claim 6, wherein if the content source is aggregated media, the transmission multiplexing ID further comprises one of:
an SDP attribute line of value list or multiple SDP attribute lines of a single value corresponding to multiple element media types in the media stream; or
an SDP attribute line of value list or multiple SDP attribute lines of a single value corresponding to the number of profiles of media related parameters of multiple element media types in the media stream.

8. The method according to claim 6, wherein the transmission multiplexing ID further comprises a multiplexing indication ID that is carried through an extended SDP attribute line.

9. A media transmission method, comprising:
receiving a media stream sent from a server;
if the media stream is media multiplexed for content-based transmission, obtaining from a transmission adaptation layer a content identifier (ID) used to indicate multiplexed content; and
parsing the media stream according to the content ID, and decoding and presenting the media stream.

10. The method according to claim 9, further comprising:
before receiving the media stream, sending a content service request message to the server;
receiving Session Description Protocol (SDP) information sent from the server, wherein the SDP information carries a content-based transmission multiplexing ID; and
selecting a content source according to a capability requirement and the content-based transmission multiplexing ID carried in the SDP information.

11. A server, comprising:
an encapsulating unit, configured to encapsulate a content source selected by a client into a data packet, and add a content identifier (ID) used to indicate multiplexed content to a transmission adaptation layer; and
a media stream sending unit, configured to send a media stream of the encapsulated data packet to the client.

12. The server according to claim 11, wherein: the encapsulating the content source into the data packet comprises: encapsulating a single data unit into a data packet; or encapsulating a single data unit fragment into a data packet; and
the encapsulating unit is configured to add a content ID of the data unit or a content ID of the data unit fragment to a data packet header.

13. The server according to claim 11, wherein: the encapsulating the content source into the data packet comprises one of: encapsulating multiple data units into a data packet on an aggregated basis; or encapsulating multiple data unit fragments into a data packet on an aggregated basis; or encapsulating multiple data units and data unit fragments into a data packet on an aggregated basis; and
the encapsulating unit is configured to at least one of: add a content ID to an aggregated data packet header; and/or add a content ID of an aggregated data unit to an aggregated data unit header;
the aggregated data unit comprises data units or data unit fragments and the aggregated data packet is an aggregation of aggregated data units.

14. The server according to claim 11, further comprising:
a service request receiving unit, configured to receive a content service request message sent from the client, wherein the message comprises the content source requested by the client;
an information generating unit, configured to generate Session Description Protocol (SDP) information corresponding to the content source after the service request receiving unit receives the content service request, wherein the SDP information carries a content-based transmission multiplexing ID; and
an information sending unit, configured to send the SDP information;
wherein, the content source is selected by the client according to a capability requirement of the client and the content-based transmission multiplexing ID carried in the SDP information.

15. A client, comprising:
a media stream receiving unit, configured to receive a media stream sent from a server;
a content identifier (ID) obtaining unit, configured to obtain from a transmission adaptation layer a content ID used to indicate multiplexed content when the media stream is media multiplexed for content-based transmission;
a parsing unit, configured to parse the media stream according to the content ID; and
a presenting unit, configured to decode and present the media stream parsed by the parsing unit.

16. The client according to claim 15, further comprising:
a service requesting unit, configured to send a content service request message to the server before receiving the media stream;
an information receiving unit, configured to receive Session Description Protocol (SDP) information sent from the server, wherein the SDP information carries a content-based transmission multiplexing ID; and
a selecting unit, configured to select a content source according to a capability requirement of the client and the content-based transmission multiplexing ID carried in the SDP information.

17. A media storage method, comprising:
storing multiplexed contents of a same multiplexed media type in a file; and
marking a content ID and a multiplexing indication on the multiplexed contents in the file.

18. The method according to claim 17, wherein:
the storing multiplexed contents of a same multiplexed media type in a file comprises:
storing each multiplexed content of the same multiplexed media type in a track of the file, wherein each sample of the multiplexed content comprises all data units of one media content with the same media time; and
the marking the content ID and the multiplexing indication on the multiplexed contents in the file comprises:
adding the content ID of multiplexed content to description information of the multiplexed contents; and
adding first multiplexing indication information to the file, wherein the first multiplexing indication information is used to indicate that the contents stored in a track are multiplexed contents.

19. The method according to claim 18, further comprising:
using track IDs of the tracks storing the multiplexed contents to indicate the content IDs of the multiplexed contents.

20. The method according to claim 18, further comprising one of:
storing the content IDs and the first multiplexing indication information at a movie level of the file; or
storing the content IDs and the first multiplexing indication information at a track level of the file.

21. The method according to claim 17, wherein:
the storing multiplexed contents of a same multiplexed media type in a file comprises:
storing all multiplexed contents of the same multiplexed media type in a track of the file, wherein each sample of the multiplexed contents comprises all data units of all the multiplexed media contents with the same media time; and
the marking the content ID and the multiplexing indication on the multiplexed contents in the file comprises:
adding a prefix before each data unit to indicate the content ID of each multiplexed content; and
adding second multiplexing indication information to the track, wherein the second multiplexing indication information is used to indicate that the contents stored in the track are multiplexed contents.

22. The method according to claim 21, further comprising:
storing the second multiplexing indication information at a track level of the file.

23. The method according to claim 22, further comprising:
storing the second multiplexing indication information in a sample entry of the track.

24. A media storage device, comprising:
a storing unit, configured to store multiplexed contents of a same multiplexed media type in a file; and
an information describing unit, configured to mark a content identifier (ID) and a multiplexing indication on the multiplexed contents in the file.

25. The media storage device according to claim 24, wherein:
the storing unit is configured to store a single multiplexed content of the same multiplexed media type in a track of the file, wherein each sample of the multiplexed content comprises data units of a single media content of the same media time; and
the information describing unit is configured to add the content ID of multiplexed content to description information of the multiplexed contents; and add first multiplexing indication information to the file, wherein the first multiplexing indication information is used to indicate that the contents stored in a track are multiplexed contents.

26. The media storage device according to claim 24, wherein:
the storing unit is configured to store all multiplexed contents of the same multiplexed media type in a track of the file, wherein each sample of the multiplexed contents comprises data units of all the media contents of the same media time; and
the information describing unit is configured to add a prefix before data unit to indicate the content ID of each multiplexed content, and add second multiplexing indication information to the track, wherein the second multiplexing indication information is used to indicate that the contents stored in the track are multiplexed contents.
